(19) United States
(12) Patent Application Publication
(10) Pub. No.: US 2026/0214148 A1
(43) Pub. Date: Jul. 23, 2026

(54) METHOD AND APPARATUS FOR QUALITY OF SERVICE SESSION MANAGEMENT OF EDGE DATA NETWORK

(71) Applicant: Telefonaktiebolaget LM Ericsson (publ), Stockholm (SE)

(72) Inventors: Hao Zeng, Guangzhou, Guangdong (CN); Jingrui Tao, Guangzhou, Guangdong (CN); Hongtao Li, Guangzhou, Guangdong (CN)

(21) Appl. No.: 19/137,722

(22) PCT Filed: Dec. 5, 2023
(86) PCT No.: PCT/EP2023/084194

§ 371 Date: Jun. 11, 2025

(30) Foreign Application Priority Data
Dec. 15, 2022 (WO) PCT/CN2022/139344

(51) Int. Cl. H04L 67/52; H04L 67/141; H04L 67/61

(52) U.S. Cl. CPC H04L 67/52; H04L 67/141; H04L 67/61

(57) ABSTRACT

Embodiments of the present disclosure provide method and apparatus for Quality of Service (QoS) session management. A method performed by a first network node in Edge Data Network (EDN) comprises sending a first message for establishing QoS session to a second network node. The message comprises a service area information, and the service area information is used to indicate that within that area a terminal device is allowed to access functional entities resident in the EDN.

### TECHNICAL FIELD

The non-limiting and exemplary embodiments of the present disclosure generally relate to the technical field of communications, and specifically to methods and apparatuses for Quality of Service (QoS) session management of Edge Data Network (EDN).

### BACKGROUND

This section introduces aspects that may facilitate a better understanding of the disclosure. Accordingly, the statements of this section are to be read in this light and are not to be understood as admissions about what is in the prior art or what is not in the prior art.

3rd Generation Partnership Project (3GPP) Technical Specification (TS) 23.558 V17.2.0 specifies the Edge Data Network (EDN). FIG. 1a shows a reference point representation of the architecture for edge enabling applications. FIG. 1a is same as FIGS. 6.2-4 of 3GPP TS 23.558 V17.2.0. The EDN is a local Data Network. Edge Application Server(s) (EASs) and the Edge Enabler Server (EES) are contained within the EDN. The Edge Configuration Server provides configurations related to the EES, including details of the Edge Data Network hosting the (edge enabler server). User Equipment (UE) contains Application Client(s) (ACs) and the Edge Enabler Client (EEC). The Edge Application Server (EAS), the EES and the Edge Configuration Server (ECs) may interact with the 3GPP core network.

The functional entities include:

Edge Enabler Server (EES): EES provides supporting functions needed for EASs and EEC, e.g., EEC registration, EAS discovery and network APIs for EAS and service continuity support.

Edge Enabler Client (EEC): EEC provides supporting functions needed for AC(s), e.g., retrieval and provisioning of configuration information to enable application data traffic, and EAS discovery.

Edge Configuration Server (ECS): ECS provides supporting functions needed for the EEC to connect with an EES, e.g., provisioning of Edge configuration information to the EEC, and EES discovery.

Application Client (AC): AC is the application resident in the UE performing the client function.

Edge Application Server (EAS): EAS is the application server resident in the EDN, performing the server functions. The AC connects to the EAS in order to avail the services of the application with the benefits of Edge Computing.

FIG. 1b shows a capability exposure for enabling edge applications. FIG. 1b is same as FIG. 6.7.1-1 of 3GPP TS 23.558 V17.2.0. Capability exposure includes the 3GPP core network (i.e. 5th Generation Core (5GC), Evolved Packet Core (EPC)), ECS and the EES capability exposure, to fulfil the needs of the edge service operations. The capability exposure functionality is utilized by the functional entities (i.e. EES, EAS and ECS) depicted in the architecture for enabling the edge applications.

FIG. 1c shows a 5th Generation (5G) System Architecture. It depicts the non-roaming reference architecture. Service-based interfaces are used within the Control Plane. FIG. 1c is same as FIG. 4.2.3-1 of 3GPP TS 23.501 V17.6.0. The 5G System architecture in FIG. 1c consists of the following network functions (NF): Authentication Server Function (AUSF), Access and Mobility Management Function (AMF), Data Network (DN), e.g. operator services, Internet access or 3rd party services, Network Exposure Function (NEF), Network Repository Function (NRF), Network Slice-specific and Stand-alone Non-Public Network (SNPN) Authentication and Authorization Function (NSSAAF), Network Slice Selection Function (NSSF), Policy Control Function (PCF), Session Management Function (SMF), Unified Data Management (UDM), User Plane Function (UPF), Application Function (AF), User Equipment (UE), (Radio) Access Network ((R)AN), and Service Communication Proxy (SCP).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

User is expected to have better QoS in a specific area in a 5th Generation (5G) Mobile Communication Technology system than the areas out of the specific area. The specific area could be a service area of an Edge Data Network or an area inside it. Take example, the area may be an office or a street.

But when the terminal device moved out from the service area of EDN, the core network node still sends PDU session status message to the network node in EDN, which is not useful and wastes communication resources. Meanwhile, the forwarding rules are stored in the legacy data plane, which is not useful and wastes data plane resources.

To overcome or mitigate at least one of above mentioned problems or other problems, the embodiments of the present disclosure propose an improved solution for session management.

In a first aspect of the disclosure, there is provided a method performed by a first network node in Edge Data Network (EDN). The method comprises sending a message for establishing Quality of Service (QoS) session to the second network node. The message comprises a service area information, and the service area information is used to indicate that within that area a terminal device is allowed to access functional entities resident in the EDN.

In an embodiment, the service area information comprises at least one of topological service area identifier and geographical service area identifier.

In an embodiment, the first message further comprises a terminal device information. The terminal device information comprising at least one of User Equipment (UE) Identifier (ID) and UE Group ID.

In an embodiment, the method further comprises receiving a second message for responding the QoS session establishment from the second network node.

In an embodiment, the first network node is an Edge Application Server (EAS) and/or the second network node is an Edge Enabler Server (EES).

In a second aspect of the disclosure, there is provided a method performed by a second network node in Edge Data Network (EDN) network. The method comprises receiving a first message for establishing QoS session from a first network node. The message comprises a service area information, and the service area information is used to indicate that within that area a terminal device is allowed to access functional entities resident in the EDN.

In an embodiment, the service area information comprises at least one of topological service area identifier and geographical service area identifier.

In an embodiment, the first message further comprises a terminal device information. The terminal device information comprising at least one of User Equipment (UE) Identifier (ID) and UE Group ID.

In an embodiment, the method further comprises sending a second message for responding the QoS session establishment to the first network node.

In an embodiment, the method further comprises sending a third message for subscribing the event monitoring service of Area of Interest to a third network node, wherein the Area of Interest indicates change of the terminal device presence in the Area of Interest.

In an embodiment, the third message comprises at least one of User Equipment (UE) Identifier (ID), UE Group ID, Area of Interest and locationArea5G. In the third message, the Area of Interest indicates change of the terminal device presence in the Area of Interest, and the locationArea5G is used to define the geographic and topological area.

In an embodiment, the method further comprises receiving a fourth message for indicating acknowledge the execution of the subscribing the event monitoring service of Area of Interest from the third network node.

In an embodiment, the method further comprises receiving a fifth message, from the third network node, for notifying change of the terminal device presence in the Area of Interest whether the terminal device enters or leaves the service area.

In an embodiment, when the terminal device enters the service area, the method further comprises sending a sixth message, to the third network node, for subscribing the event monitoring service of Packet Data Unit (PDU) session status when the terminal device enters the service area.

In an embodiment, the method further comprises receiving a seventh message, from the third network node, for indicating acknowledge the execution of the sixth message.

In an embodiment, the method further comprises receiving an eighth message, from the third network node, for indicating PDU session status.

In an embodiment, the method further comprises sending a ninth, to the third network node, for creating an QoS session with required QoS. The method further comprises receiving a tenth message, from the third network node, for indicating acknowledge of the execution of the ninth message.

In an embodiment, when the terminal device leaves the service area, the method further comprises sending an eleventh message to the third network node, for unsubscribing the event monitoring service of PDU session status.

In an embodiment, the method further comprises receiving a twelfth message, from the third network node, for indicating acknowledge of the eleventh message.

In an embodiment, the method further comprises sending a thirteenth message, to the third network node, for revoking the session with QoS service. The method further comprises receiving a fourteenth message, from the third network node, indicating acknowledge of execution of the thirteenth message.

In an embodiment, the first network node is an Edge Application Server (EAS), and/or the second network node is an Edge Enabler Server (EES), and/or the third network node is Network Exposure Function (NEF).

In a third aspect of the disclosure, there is provided a method performed by a third network node in Edge Data Network (EDN) network. The method comprises receiving a third message, from the second network node, for subscribing the event monitoring service of location change of the terminal device.

In an embodiment, the message comprising at least one of User Equipment (UE) Identifier (ID), UE Group ID, Area of Interest or locationArea5G. In the third message, the Area of Interest indicates change of the terminal device presence in the Area of Interest, and the locationArea5G is used to define the geographic and topological area.

In an embodiment, the method further comprises sending a fourth message, to the second network node, for indicating acknowledge the execution of the third message.

In an embodiment, the method further comprises sending a fifth message, to the second network node, for notifying change of the terminal device presence in the Area of Interest when the terminal device enters or leaves the service area.

In an embodiment, when the terminal device enters the service area, the method further comprises receiving a sixth message, from the second network node, for subscribing the event monitoring service of Packet Data Unit (PDU) session status.

In an embodiment, the method further comprises sending a seventh message, to the second network node, for indicating acknowledge the execution of the sixth message.

In an embodiment, the method further comprises sending an eighth message, to the second network node, for indicating PDU session status.

In an embodiment, the method further comprises receiving a nineth message, from the second network node, for creating an QoS session with required QoS. The method further comprises sending a tenth message, to the second network node, for indicating acknowledge of the execution of the ninth message.

In an embodiment, when the terminal device leaves the service area, the method further comprises receiving an eleventh message, from the second network node, to unsubscribe the PDU session status monitoring service.

In an embodiment, when the terminal device leaves the service area, the method further comprises sending a twelfth message, to the second network node, for indicating acknowledge of the execution of the eleventh message.

In an embodiment, the method further comprises receiving a thirteenth message, from the second network node, for revoking the session with QoS service. The method further comprises sending a fourteenth message, to the second network node, for indicating acknowledge of execution of the thirteenth message.

In an embodiment, the second network node is an Edge Enabler Server (EES), and the third network node is Network Exposure Function (NEF).

In a fourth aspect of the disclosure, there is provided a first network node. The network node comprises a processor and a memory coupled to the processor. Said memory contains instructions executable by said processor. Said network node is operative to send a first message for establishing Quality of Service (QoS) session to a second network node. The first message comprising a service area information, and the service area information is used to indicate that within that area a terminal device is allowed to access functional entities resident in the EDN.

In a fifth aspect of the disclosure, there is provided a second network node. The network node comprises a processor and a memory coupled to the processor. Said memory contains instructions executable by said processor. Said network node is operative to receive a first message for establishing QoS session from a first network node. The first message comprising a service area information, and the service area information is used to indicate that within that area a terminal device is allowed to access functional entities resident in the EDN.

In a sixth aspect of the disclosure, there is provided a third network node. The network node comprises a processor and a memory coupled to the processor. Said memory contains instructions executable by said processor. Said network node is operative to receive a third message, from the second network node, for subscribing the event monitoring service of location change of the terminal device.

In a seventh aspect of the disclosure, there is provided a computer-readable storage medium storing instructions which when executed by at least one processor, cause the at least one processor to perform the method according to any one of the first, second, and third aspects.

In an eighth aspect of the disclosure, there is provided a communication system. The communication system comprises a first network node, a second network node and a third network node. The first network node sends a first message for establishing Quality of Service (QoS) session to a second network node. The first message comprises a service area information, and the service area information is used to indicate that within that area a terminal device is allowed to access functional entities resident in the EDN. The second network node sends a second message for subscribing the event monitoring service of Area of Interest to a third network node. The Area of Interest indicates change of the terminal device presence in the Area of Interest.

Embodiments herein may provide many advantages, of which a non-exhaustive list of examples follows. It proposes a solution to improve the QoS of the session, by e.g. monitoring the UE location when UE enters or leaves the service area of EDN, and remove the unnecessary communication messages between core network and EDN when UE moves out of the service area of EDN, or by monitoring the UE location when UE enters or leaves the service area of EDN, and delete the unnecessary storage space in user plane when UE moves out of the service area of EDN. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a shows a reference point representation of the architecture for edge enabling applications;

FIG. 1b shows a capability exposure for enabling edge applications;

FIG. 1c shows a 5G System Architecture;

FIG. 2a shows a session with QoS API create operation;

FIG. 2b shows a NEF monitoring service flow;

FIG. 3a shows an example of terminal device in the service area of EDN;

FIG. 3b shows an example of terminal device out of the service area of EDN;

FIG. 4 shows a flowchart of a method according to an embodiment of the present disclosure;

FIG. 5 shows a flowchart of a method according to another embodiment of the present disclosure;

FIG. 6 shows a flowchart of a method according to another embodiment of the present disclosure;

FIG. 7 shows a flowchart of an embodiment of the present disclosure;

FIG. 8 is a block diagram showing an apparatus suitable for practicing some embodiments of the disclosure;

FIG. 9a is a block diagram showing a network function according to an embodiment of the disclosure;

FIG. 9b is a block diagram showing a network function according to an embodiment of the disclosure;

FIG. 9c is a block diagram showing a network function according to an embodiment of the disclosure;

FIG. 10 shows an example of a communication system according to an embodiment of the disclosure;

FIG. 11 is a block diagram of a host according to an embodiment of the disclosure; and

FIG. 12 shows a communication diagram of a host communicating via a network node with a UE over a partially wireless connection according to an embodiment of the disclosure.

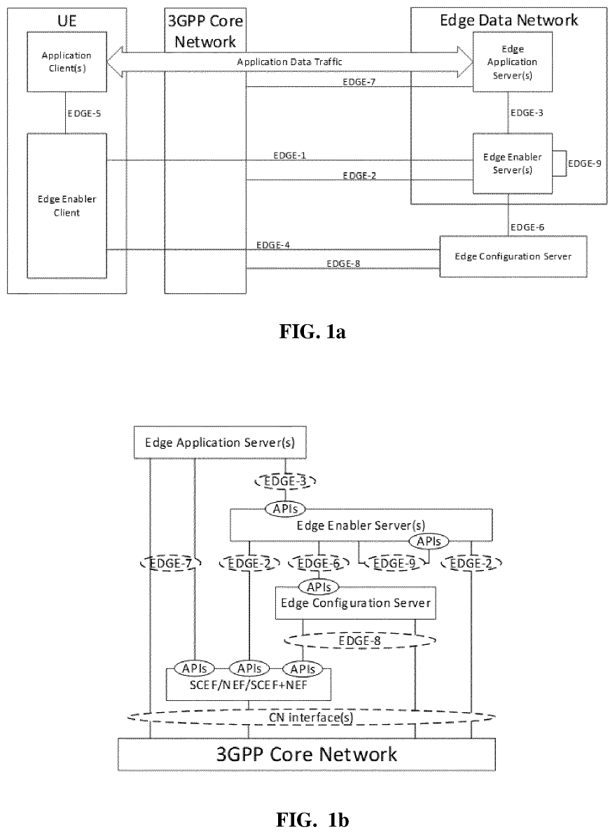

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” refers to any suitable network function (NF) which can be implemented in a network function (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network node may comprise different types of NFs for example depending on a specific network.

The term “terminal device” or “user equipment (UE)” refers to any end device that can access a communication network and receive services therefrom. By way of example and not limitation, the terminal device refers to a mobile terminal or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a Laptop-Embedded Equipment (LEE), a Laptop-Mounted Equipment (LME), a Universal Serial Bus (USB) dongle, a smart device, a wireless Customer-Premises Equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

User is expected to have better QoS in a specific area in a 5th Generation (5G) Mobile Communication Technology system than the areas out of the specific area. The specific area could be an Edge Data Network or an area inside it. Take example, the area could be an office or a street.

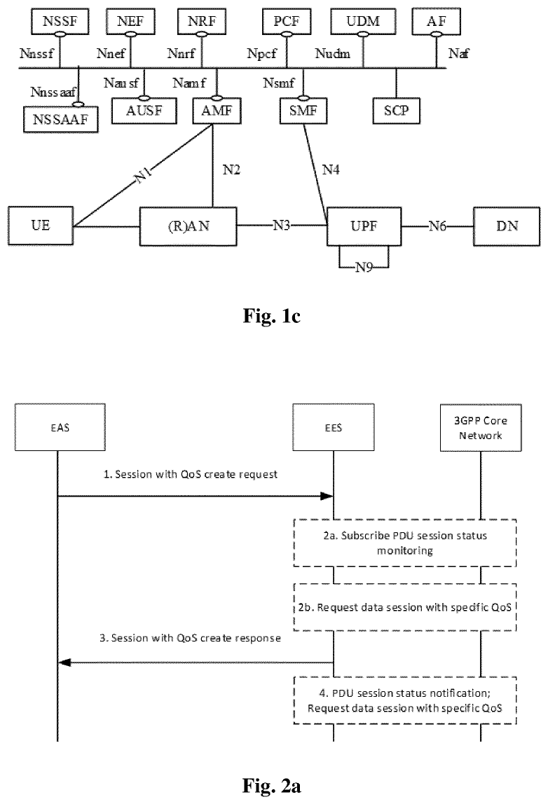

FIG. 2a is a current solution for above scenario. For edge computing, Edge Application Server (EAS) may invoke EES QoS API to set QoS for subscribers, which is described in FIG. 2a. FIG. 2a illustrates the session with QoS create operation between the EAS and the EES. It is used to request reservation of resources for a data session between AC and EAS with a specific QoS and to subscribe to certain session with QoS event notifications. The detailed procedure is described in clause 8.6.6.2 of 3GPP TS 23.558 V17.2.0.

At step 1, the EAS requests establishment of a data session between the Application Client (AC) and the EAS with a specific QoS (either QoS reference or bandwidth). AC is the application resident in the UE performing the client function. If the data session can adjust to different QoS parameter combinations, the request may include a list of alternative QoS references in a priority order. The EAS shall include the UE's IP address, UE ID or UE Group ID, the DNN and S-NSSAI used for the data session between AC and EAS. With the same request the EAS subscribes to receive certain session with QoS event notifications (e.g. notifications related to QoS monitoring, usage monitoring for sponsored data connectivity and/or QoS targets can no longer (or can again) be fulfilled).

At step 2, the EES checks if the EAS is authorized for this operation for the UE. If authorized, then the following services of 3GPP Core Network may be used by the EES:
a. the EES invokes the Event Monitoring service for PDU session status with the 3GPP Core Network.
b. the EES invokes the Policy Authorization Create service or the AF Session with QoS service with the 3GPP Core Network (PCF or NEF, respectively), providing the specific QoS (QoS reference or bandwidth) to the PCF. Additionally, the EES may subscribe to notifications of resource allocation outcome and to other events, e.g. notifications of when the QoS targets can no longer (or can again) be fulfilled.

The usage of step 2a and step 2b is as follows:
If the request is for a group of UEs identified by the UE Group ID or for a single UE identified by the UE ID, then EES executes step 2a. If UE (single UE or UE group member) already has ongoing PDU session, then UE IP address is retrieved in step 2a. Further the EES executes step 2b; otherwise the EES waits for further notification for PDU session status in step 4.
If the request is for a single UE identified by the IP address, then EES executes step 2b.

At step 3, if the operation in step 2 is successful, the EES responds with a Context ID and a Result. The Context ID is to be used by the EAS for further requests (e.g. session with QoS update requests) pertaining to the same UE. If the EAS is not authorized or any other failure happens during the operation, the EES provides a rejection response with cause information.

At step 4, when the EES receives the corresponding UE IP address for the single UE or UE group member from the PDU session status notification sent by the 3GPP Core Network, the EES requests data session with specific QoS as described in step 2b.

NOTE: The EES will report the resource allocation outcome, e.g. the successful allocation of the Service Data Flow(s) related to the data session, with a separate session with QoS notify operation.

FIG. 2b shows the NEF monitoring service information flow. The Monitoring Events feature is intended for monitoring of specific events in 3GPP system and making such monitoring events information reported via the NEF. It is comprised of means that allow Network Functions (NFs) in 5GS for configuring the specific events, the event detection, and the event reporting to the requested party. The detailed procedure is described in clause 4.15.3.2.3 of 3GPP TS 23.502 V17.3.0.

At step 1, AF subscribes to one or several Event(s) (identified by Event ID) and provides the associated notification endpoint of the AF by sending Nnef_EventExposure_Subscribe request.

Event Reporting Information defines the type of reporting requested (e.g. one-time reporting, periodic reporting or event based reporting, for Monitoring Events). If the reporting event subscription is authorized by the NEF, the NEF records the association of the event trigger and the requester identity. The subscription may also include Maximum number of reports and/or Maximum duration of reporting Information Element (IE) and optionally MTC Provider Information.

If subscription to group-based event notifications are removed or added for certain UEs in a group of UEs for which there is an event notification subscription, the AF provides impacted UE information (e.g. Subscription Permanent Identifier (SUPI), Mobile Subscriber Integrated Services Digital Number (MSISDN) or External Identity) with operation indication which is either cancellation or addition to NEF via Nnef_EventExposure_Subscribe without cancelling the entire group-based event notification subscription.

At Step 2 [Conditional—depending on authorization in step 1], the NEF subscribes to received Event(s) (identified by Event ID) and provides the associated notification endpoint of the NEF to UDM by sending Nudm_EventExposure_Subscribe request. The NEF may either receive DNN, S-NSSAI from AF in step 1 or maps the AF-Identifier into DNN and S-NSSAI combination based on local configuration, and include DNN, S-NSSAI in the request.

If the reporting event subscription is authorized by the UDM, the UDM records the association of the event trigger and the requester identity. Otherwise, the UDM continues in step 4 indicating failure.

If Nnef_EventExposure_Subscribe with update is received in step 1 indicating removal of event notification subscription for certain UEs in a group of UEs for which there is an event notification subscription, the NEF provides impacted UE information (e.g. SUPI, MSISDN, or External Identity) with operation indication (cancellation) to UDM via Nudm_EventExposure_Subscribe without cancelling the entire group-based event notification subscription. If the Maximum Number of Reports applies to the event subscription, the NEF sets the stored number of reports of the indicated UE(s) to Maximum Number of Reports.

If Nnef_EventExposure_Subscribe with update is received in step 1 indicating addition of event notification subscription for certain UEs in a group of UEs for which there is an event notification subscription, the NEF provides impacted UE information (e.g. SUPI, MSISDN or External Identity) with indication operation (addition) to UDM via Nudm_EventExposure_Subscribe.

At Step 3a [Conditional], if the requested event (e.g. monitoring of Loss of Connectivity) requires AMF assistance, then the UDM sends the Namf_EventExposure_Subscribe to the AMF serving the requested user. The UDM sends the Namf_EventExposure_Subscribe request to the all serving AMF(s) (if subscription applies to a UE or a group of UE(s)), or all the AMF in the same PLMN as the UDM (if subscription applies to any UE).

NOTE 1: If the UE, which is a member of a group, registers with an AMF which does not have group event subscription(s) for that group, then the UDM creates subscriptions to those event(s) with the AMF during the Registration procedure.

As the UDM itself is not the Event Receiving NF, the UDM shall additionally provide the notification endpoint of itself besides the notification endpoint of NEF. Each notification endpoint is associated with the related (set of) Event ID(s). This is to assure the UDM can receive the notification of subscription change related event.

If the subscription applies to a group of UE(s), the UDM shall include the same notification endpoint of itself, i.e. Notification Target Address (+Notification Correlation Id), in the subscriptions to all UE's serving AMF(s).

NOTE 2: The same notification endpoint of UDM is to help the AMF identify whether the subscription for the requested group event is same or not when a new group member UE is registered.

If Nudm_EventExposure_Subscribe with update is received in step 2 indicating removal of event notification subscription for certain UEs in a group of UEs for which there is an event notification subscription, the UDM provides impacted UE information (e.g. SUPI, MSISDN) with operation indication (cancellation) to AMF via Namf_EventExposure_Subscribe without cancelling the entire group-based event notification subscription, for the event monitored by AMF.

If Nudm_EventExposure_Subscribe with update is received in step 2 indicating addition of event notification subscription for certain UEs in a group of UEs for which there is an event notification subscription, the UDM provides impacted UE information (e.g. SUPI, MSISDN) with operation indication (addition) to AMF via Namf_EventExposure_Subscribe for the event monitored by AMF.

At step 3b [Conditional], AMF acknowledges the execution of Namf_EventExposure_Subscribe.

At step 3c [Conditional], if the requested event (e.g. PDU Session Status) requires SMF assistance, then the UDM sends the Nsmf_EventExposure_Subscribe Request message to each SMF where at least one UE identified in step 2 has a PDU session established. The NEF notification endpoint received in step 2 is included in the message.

NOTE 3: In the home routed case, the UDM sends the subscription to the V-SMF via the H-SMF.

At step 3d [Conditional], the SMF acknowledges the execution of Nsmf_EventExposure_Subscribe.

At step 4 [Conditional], UDM acknowledges the execution of Nudm_EventExposure_Subscribe.

If the subscription is applicable to a group of UE(s) and the Maximum number of reports is included in the Event Report information in step 1, the Number of UEs (including all group member UEs irrespective of their registration state) is included in the acknowledgement. If AMF or SMF provides the first event report in step 3b or step 3d, the UDM includes the event report in the acknowledgement.

At step 5, NEF acknowledges the execution of Nnef_EventExposure_Subscribe to the requester that initiated the request. If the NEF has received the first event report already in step 4, the NEF includes the event report in the acknowledgement.

At step 6a-6b [Conditional—depending on the Event], the UDM (depending on the Event) detects the event occurs and sends the event report, by means of Nudm_EventExposure_Notify message to the associated notification endpoint of the NEF along with the time stamp. NEF may store the information in the UDR along with the time stamp using either Nudr_DM_Create or Nudr_DM_Update service operation as appropriate.

If Nudm_EventExposure_Subscribe with update is received in step 2 indicating removal of event notification subscription for certain UEs in a group of UEs for which there is an event notification subscription, the UDM shall stop the event notification for the impacted UEs. If Maximum number of Reports is applied, the UDM shall set the number of reports of the indicated UE(s) to Maximum Number of Reports for the events monitored by UDM.

If Nudm_EventExposure_Subscribe with update is received in step 2 indicating addition of event notification subscription for certain UEs in a group of UEs for which there is an event notification subscription, the UDM shall create subscription to the event notification for the impacted UEs so as to detect the monitored event and send the event report for such impacted UEs.

At step 6c-6d [Conditional—depending on the Event], the AMF detects the event occurs and sends the event report, by means of Namf_EventExposure_Notify message to associated notification endpoint of the NEF along with the time stamp. NEF may store the information in the Unified Data Repository (UDR) along with the time stamp using either Nudr_DM_Create or Nudr_DM_Update service operation as appropriate.

If the AMF has a maximum number of reports stored for the UE or the individual member UE, the AMF shall decrease its value by one for the reported event.

If Namf_EventExposure_Subscribe with update is received in step 3a indicating removal of event notification subscription for certain UEs in a group of UEs for which there is an event notification subscription, the AMF shall stop the event notification for the impacted UEs. If Maximum number of Reports is applied, the AMF shall set the number of reports of the indicated UE(s) to Maximum Number of Reports.

If Namf_EventExposure_Subscribe with update is received in step 3a indicating addition of event notification subscription for certain UEs in a group of UEs for which there is an event notification subscription, the AMF shall create subscription to the event notification for the impacted UEs so as to detect the monitored event and send the event report for such impacted UEs.

For both step 6a and step 6c, when the maximum number of reports is reached and if the subscription is applied to a UE, The NEF unsubscribes the monitoring event(s) to the UDM and the UDM unsubscribes the monitoring event(s) to AMF serving for that UE.

For both step 6a and step 6c, when the maximum number of reports is reached for an individual group member UE, the NEF uses the Number of UEs received in step 4 and the Maximum number of reports to determine if reporting for the group is complete. If the NEF determines that reporting for the group is complete, the NEF unsubscribes the monitoring event(s) to the UDM and the UDM unsubscribes the monitoring event(s) to all AMF(s) serving the UEs belonging to that group.

NOTE 4: If an expiry time is not included in the event subscription, then the life time of the event subscription needs to be controlled by other means as there is no time based cancellation at all even if any group member UEs fail to register.

When the Maximum duration of reporting expires in the NEF, the UDM and the AMF, then each of these nodes shall locally unsubscribe the monitoring event.

At step 6e-6f [Conditional—depending on the Event], when the SMF detects a subscribed event, the SMF sends the event report, by means of Nsmf_EventExposure_Notify message, to the associated notification endpoint of the NEF provided in step 3c. NEF may store the information in the UDR along with the time stamp using either Nudr_DM_Create or Nudr_DM_Update service operation as appropriate.

At step 7 [Conditional—depending on the Event in steps 6a-6f], the NEF forwards to the AF the reporting event received by either Nudm_EventExposure_Notify and/or Namf_EventExposure_Notify. In the case of the PDU Session Status event, the NEF maps it to an PDN Connectivity Status notification when reporting to the AF.

At step 8 [Conditional—depending on the Event], the AMF detects the subscription change related event occurs, e.g. Subscription Correlation ID change due to AMF reallocation or addition of new Subscription Correlation ID due to a new group UE registered, it sends the event report, by means of Namf_EventExposure_Notify message to the associated notification endpoint of the UDM.

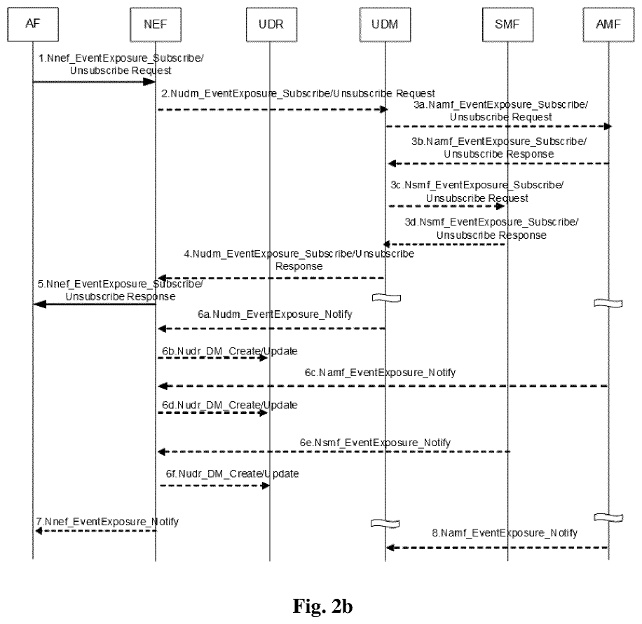

The procedure is described below with reference of FIG. 3a and FIG. 3b:

Step 1: EAS invokes EES QoS API to set QoS for a UE.

Step 2: EES invokes NEF monitoring event API to subscribe PDU session status event. FIG. 2b shows the NEF monitoring service information flow.

Step 3: NEF replies to EES the UE's PDU session status info, such as UE allocated IP address, to EES.

Step 4: EES invokes NEF QoS API to set QoS between the UE and the EAS in the EDN.

Step 5: NEF sets corresponding QoS rules to UPF and Radio Access Network. After that, the PDU session between the UE and EAS gets expected QoS. Note that the PDU session goes through the UPF in the edge data network.

Step 6: When the UE moves out the service area of the EDN, the UE may change the anchored UPF, the UE PDU session is updated. NEF will send PDU session status notification to EES. EES then invokes NEF QoS API to set QoS for the UE and the EAS in the EDN.

When User Equipment (UE) moves out the service area of an EDN, and moves into the service area of a central network, UE is re-anchored to the UPF in the central network. During this time, Edge Application Server, Cloud Application Server and the UE perform application context reallocation. The UE establishes a new application session with the Cloud Application Server in the central network.

The new application session goes through UPF in the central network, and doesn't go through the UPF in the EDN anymore.

However, during this period, NEF still sends PDU session status notification to EES, which is not useful. Meanwhile, though UE moves out of the service area, EES doesn't revoke the legacy QoS session (from UE to EAS) to NEF. When UE moves into the service area of EDN later, the EES will send QoS session create request to NEF. Then a new QoS session between UE and EAS will be create. At that time, the old QoS session is still exist, and the configurations and resources of the network nodes in EDN and Core network which maintains the QoS session are waisted. Further, QoS rules between UE and EAS are still installed in RAN and UPF which will not take effect, because UE cannot connect to the EAS. Then, the communication and storage resources are wasted.

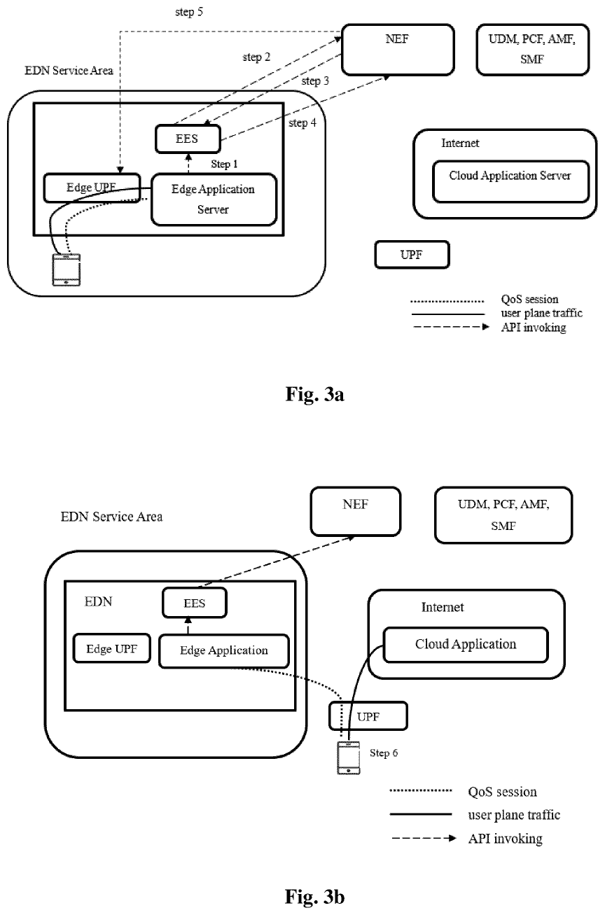

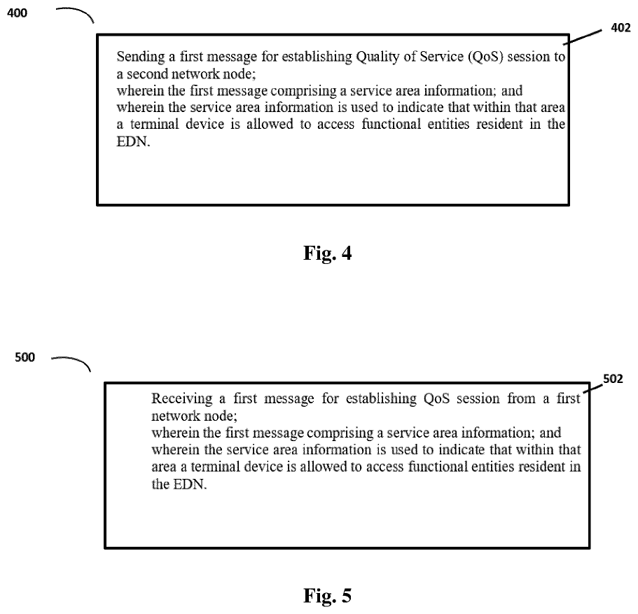

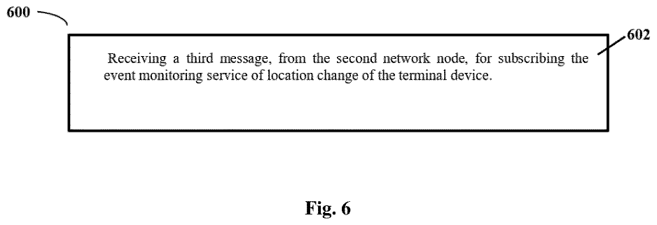

FIG. 4, FIG. 5, FIG. 6 show flowcharts of methods according to an embodiment of the present disclosure, which may be performed by an apparatus implemented in or at or as a first network node, second network node, and third network node, or communicatively coupled to these network nodes.

The first network node may be a physical entity or a virtualized network function. For example, the network node may be any suitable network device or node or entity or function (physical or virtual) which can provide a function for setting up or responding a session with required QoS.

In an embodiment, the first network node may comprise an Edge Application Server (EAS).

EAS may be an application server resident in the EDN, performing the server functions. The EAS may be a physical entity or a virtualized network function. For example, the EAS may be any suitable network device or node or entity or function (physical or virtual) which can provide a means to securely expose the services and capabilities provided by the network interfaces. The EAS may provide a means for invoking 3GPP Core Network capabilities via the edge enabler layer through the EES. The EAS may provide a means for invoking 3GPP Core Network function (e.g. PCF) APIs directly, if it is an entity trusted by the 3GPP Core Network. The EAS may provide a means for invoking the 3GPP Core Network capabilities through the capability exposure functions i.e. SCEF/NEF/SCEF+NEF.

The second network node may be a physical entity or a virtualized network function. For example, the second network node may be any suitable network device or node or entity or function (physical or virtual) which can provide supporting functions as follows.

In an embodiment, the second network node may be an Edge Enabler Server (EES).

It may provide a means for provisioning of configuration information to EEC, enabling exchange of application data traffic with the EAS. It may provide a means for providing API invoker and API exposing functions. It may provide a means for interacting with 3GPP Core Network for accessing the capabilities of network functions either directly (e.g. via PCF) or indirectly (i.e. SCEF/NEF/SCEF+NEF). It may provide a means for exposing events related to ACT. It may provide a means for EEC context transfer between EESs. It may provide a means for supporting external exposure of 3GPP network and service capabilities to the EAS(s) over EDGE-3. It may provide a means for registration functions (i.e., registration, update, and de-registration) for the EEC(s) and the EAS(s). It may provide a means for triggering the EAS instantiation on demand.

The third network node may be a physical entity or a virtualized network function. For example, the third network node may be any suitable network device or node or entity or function (physical or virtual) which can provide supporting functions as follows.

In an embodiment, the third network node may comprise a Network Exposure Function (NEF).

The third network node may be a physical entity or a virtualized network function. For example, the exposure node may be any suitable network device or node or entity or function (physical or virtual) which can provide a means to securely expose the services and capabilities provided by the network interfaces. The exposure node may provide a means for the discovery of the exposed services and capabilities. The exposure node may provide access to network capabilities through homogenous network application programming interfaces (e.g. Network APIs). The exposure node may abstract the services from the underlying network interfaces and protocols.

FIG. 4 shows a flowchart of a method according to an embodiment of the present disclosure, which may be performed by an apparatus implemented in or at or as a first network node or communicatively coupled to the first network node. As such, the apparatus may provide means or modules for accomplishing various parts of the method 400 as well as means or modules for accomplishing other processes in conjunction with other components.

At block 402, the first network node may send a first message for establishing Quality of Service (QoS) session to a second network node. The first message may comprises a service area information. The service area information may take any suitable form, such as an array, an indication, or a bit, or a flag, etc. The service area information is used to indicate that within that area a terminal device is allowed to access functional entities resident in the EDN.

In an embodiment, the service area information may comprise at least one of topological service area identifier, and geographical service area identifier. The topological service area identifier and geographical service area identifier may take any suitable form, such as an array, an indication, or a bit, or a flag, etc.

The first message may be any suitable message, such as a request, a response, a HyperText Transfer Protocol (HTTP) Post request, a HTTP Get request, a HTTP post response, a HTTP Get response, etc. In an embodiment, the first message may be session with QoS create request as described in clause 8.6.6.2.2 of 3GPP TS 23.558 V17.2.0. The request comprises Service Area, a list of alternative QoS references in a priority order, and terminal device information in it.

In an embodiment, the first message may further comprises a terminal device information. The terminal device information may be any suitable information which can be used to identify the one or more terminal devices. The terminal device information may comprise at least one of User Equipment (UE) Identifier (ID), UE Group ID, UE Internet Protocol (IP) address, Data Network Name (DNN) and Single Network Slice Selection Assistance Information (S-NSSAI) in it. The identification information of a UE may be an identifier or a UE address (such as IP address or Media Access Control (MAC) address), SUPI, MSISDN, external ID.

In an embodiment, the first message is sent for creating QoS session when the terminal device enters or leaves the serving area of EDN.

In an embodiment, the first message may be a session with QoS create request.

In an embodiment, the first network node may receive a second message for responding the QoS session establishment from the second network node. The second message may be any suitable message, such as a request, a response, a HTTP Post request, a HTTP Get request, a HTTP post response, a HTTP Get response, etc.

In an embodiment, the second message may be a session with QoS create response.

The first and second network node may be a physical entity or a virtualized network function. For example, the network node may be any suitable network device or node or entity or function (physical or virtual) which can provide a function for setting up or responding a session with required QoS.

In an embodiment, the first network node may comprise an Edge Application Server (EAS).

In an embodiment, the second network node may be an Edge Enabler Server (EES).

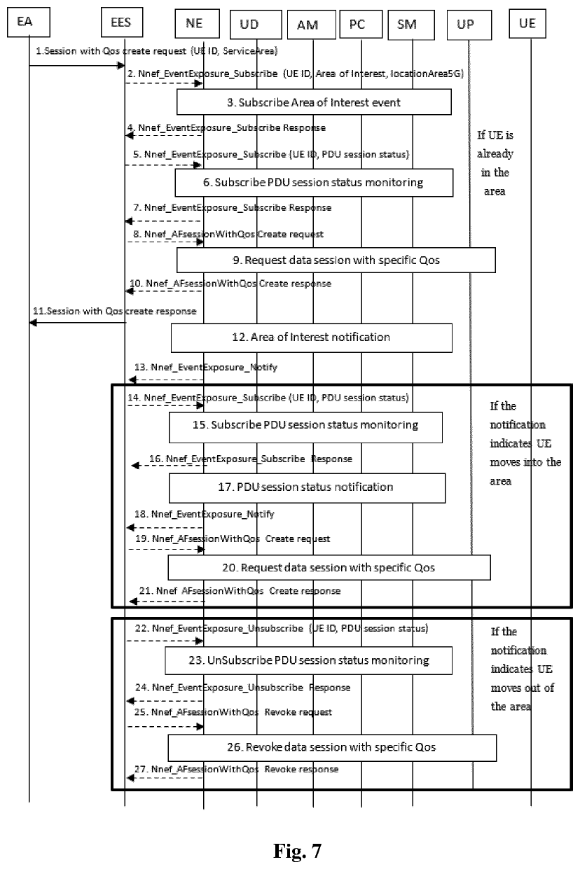

For example, as shown in FIG. 7, at step 1, EAS may send a first message to EES to request establishment of a data session with a specific QoS (either QoS reference or bandwidth). The request may comprise a new attribute Service Area in it. The service area information is used to indicate that within that area a terminal device is allowed to access functional entities resident in the EDN. The request may further comprise at least one of UE ID, User Equipment (UE) Identifier (ID), UE Group ID, DNN, S-NSSAI, IP address and Specific QoS reference in it. the first message may be a session with QoS create request. At step 11, EAS may receive a second message from EES. The second message may be a response message. It may comprise a Context ID and a Result. The Context ID is to be used by the EAS for further requests (e.g. session with QoS update requests) pertaining to the same UE.

According to various embodiments, the first network node makes the second network node which can communicate with core network know the service area of a terminal device or a group of terminal device in the EDN. Then the second network node may send it to the network nodes of Core network later, then the network nodes in the Core network will know the service area of a terminal device or a group of terminal device in the EDN. When the terminal device enters or leaves the service area, the network nodes in the Core network may send notification back to the EDN.

FIG. 5 shows a flowchart of a method according to an embodiment of the present disclosure, which may be performed by an apparatus implemented in or at or as a second network node or communicatively coupled to the second network node. As such, the apparatus may provide means or modules for accomplishing various parts of the method 500 as well as means or modules for accomplishing other processes in conjunction with other components.

At block 502, the second network node may receive a first message for establishing QoS session from a first network node. The first message may comprise a service area information. The service area information may take any suitable form, such as an array, an indication, or a bit, or a flag, etc. The service area information is used to indicate that within that area a terminal device is allowed to access functional entities resident in the EDN.

In an embodiment, the service area information comprises one of topological service area identifier, and geographical Service area identifier. The topological service area identifier and geographical service area identifier may take any suitable form, such as an array, an indication, or a bit, or a flag, etc.

In an embodiment, the first message may further comprise a terminal device information. The terminal device information may be any suitable information which can be used to identify the one or more terminal devices. The terminal device information may comprise at least one of User Equipment (UE) Identifier (ID), UE Group ID, UE IP address, DNN and S-NSSAI in it. The identification information of a UE may be an identifier or a UE address (such as IP address or MAC (Media Access Control) address), SUPI, MSISDN, external ID.

In an embodiment, the first request may be session with QoS create request as described in clause 8.6.6.2.2 of 3GPP TS 23.558 V17.2.0. The request comprises Service Area, a list of alternative QoS references in a priority order, and terminal device information in it.

The first message may be any suitable message, such as a request, a response, a HTTP Post request, a HTTP Get request, a HTTP post response, a HTTP Get response, etc.

In an embodiment, the second network node may send a second message for responding the QoS session establishment to the first network node.

In an embodiment, the second network node may send a third message for subscribing the event monitoring service of Area of Interest to a third network node. The Area of Interest indicates change of the terminal device presence in the Area of Interest.

In an embodiment, the second network node may map the Service area to locationArea5G. The locationArea5G may take any suitable form, it is used to define the geographic and topological area served by EDN which need to be monitored.

In an embodiment, the third message may comprise at least one of User Equipment (UE) Identifier (ID), UE Group ID, Area of Interest, and locationArea5G in it. The locationArea5G is used to define the geographic and topological area.

In an embodiment, the second network node may receive a fourth message for indicating acknowledge the execution of the subscribing the event monitoring service of Area of Interest from the third network node.

In an embodiment, the second network node may receive a fifth message, from the third network node, for notifying change of the terminal device presence in the Area of Interest whether the terminal device enters or leaves the service area.

In an embodiment, when the terminal device enters the service area, the second network node may send a sixth message, to the third network node, for subscribing the event monitoring service of Packet Data Unit (PDU) session status.

In an embodiment, the second network node may receive a seventh message, from the third network node, for indicating acknowledge the execution of the sixth message.

In an embodiment, the second network node may receive an eighth message, from the third network node, for indicating PDU session status.

In an embodiment, the second network node may send a ninth, to the third network node, for creating an QoS session with required QoS, and it may receive a tenth message, from the third network node, for indicating acknowledge of the execution of the ninth message.

In an embodiment, when the terminal device leaves the service area, the second network node may send an eleventh message to the third network node, for unsubscribing the event monitoring service of PDU session status.

In an embodiment, the second network node may further receive a twelfth message, from the third network node, for indicating acknowledge of the eleventh message.

In an embodiment, the second network node may further send a thirteenth message, to the third network node, for revoking the session with QoS service, and receive a fourteenth message, from the third network node, indicating acknowledge of execution of the thirteenth message.

Any message as described in above embodiments may be any suitable message, such as a request, a response, a HTTP Post request, a HTTP Get request, a HTTP post response, a HTTP Get response, etc.

The first, second, third network node may be a physical entity or a virtualized network function. For example, the network node may be any suitable network device or node or entity or function (physical or virtual) which can provide a function for setting up or responding a session with required QoS.

In an embodiment, the first network node may comprise an Edge Application Server (EAS).

In an embodiment, the second network node may be an Edge Enabler Server (EES).

In an embodiment, the third network node may comprise a Network Exposure Function (NEF).

For example, as shown in FIG. 7, at step 1, EES may receive a first message from EAS. The first message is used to request establishment of a data session with a specific QoS (either QoS reference or bandwidth). The request may comprise a new attribute Service Area in it. The service area information is used to indicate that within that area a terminal device is allowed to access functional entities resident in the EDN. The request may further comprise at least one of UE ID, User Equipment (UE) Identifier (ID), UE Group ID, DNN, S-NSSAI, IP address and Specific QoS reference in it. At step 11, the EES may send a second message for responding the QoS session establishment to the EAS.

At step 3, the EES may send a third message for subscribing the event monitoring service of Area of Interest to NEF. The Area of Interest indicates change of the terminal device presence in the Area of Interest.

At step 4, the EES may receive a fourth message for indicating acknowledge the execution of the subscribing the event monitoring service of Area of Interest from the NEF.

At step 13, the EES may receive a fifth message, from the NEF, for notifying change of the terminal device presence in the Area of Interest whether the terminal device enters or leaves the service area.

At step 14, when the terminal device enters the service area, the EES may send a sixth message, to the NEF, for subscribing the event monitoring service of Packet Data Unit (PDU) session status.

At step 16, the EES may receive a seventh message, from the NEF, for indicating acknowledge the execution of the sixth message.

At step 18, the EES may receive an eighth message, from the NEF, for indicating PDU session status.

At step 19, the EES may send a ninth, to the NEF, for creating an QoS session with required QoS, and it may receive a tenth message at step 21, from the NEF, for indicating acknowledge of the execution of the ninth message.

At step 22, when the terminal device leaves the service area, the EES may send an eleventh message to the NEF, for unsubscribing the event monitoring service of PDU session status.

At step 24, the EES may further receive a twelfth message, from the NEF, for indicating acknowledge of the eleventh message.

At step 25, the EES may further send a thirteenth message, to the NEF, for revoking the session with QoS service, and receive a fourteenth message, from the NEF, indicating acknowledge of execution of the thirteenth message.

FIG. 6 shows a flowchart of a method according to an embodiment of the present disclosure, which may be performed by an apparatus implemented in or at or as a third network node or communicatively coupled to the third network node. As such, the apparatus may provide means or modules for accomplishing various parts of the method 600 as well as means or modules for accomplishing other processes in conjunction with other components.

At block 602, the third network node may receive a third message, from the second network node, for subscribing the event monitoring service of location change of the terminal device.

The third message may be any suitable message, such as a request, a response, a HTTP Post request, a HTTP Get request, a HTTP post response, a HTTP Get response, etc.

In an embodiment, the third message may comprises at least one of User Equipment (UE) Identifier (ID), UE Group ID, Area of Interest, and locationArea5G in it. The Area of Interest indicates change of the terminal device presence in the Area of Interest. The locationArea5G is used to define the geographic and topological area served by EDN which need to be monitored.

In an embodiment, the third network node may further send a fourth message, to the second network node, for indicating acknowledge the execution of the third message.

In an embodiment, the third network node may further send a fifth message, to the second network node, for notifying change of the terminal device presence in the Area of Interest when the terminal device enters or leaves the service area.

In an embodiment, when the terminal device enters the service area, the third network node may further receive a sixth message, from the second network node, for subscribing the event monitoring service of Packet Data Unit (PDU) session status.

In an embodiment, after receiving the sixth message, the third network node may further send a seventh message, to the second network node, for indicating acknowledge the execution of the sixth message.

In an embodiment, the third network node may further send an eighth message, to the second network node, for indicating PDU session status.

In an embodiment, the third network node may further receive a nineth message, from the second network node, for creating an QoS session with required QoS, and send a tenth message, to the second network node, for indicating acknowledge of the execution of the ninth message.

In an embodiment, the terminal device leaves the service area, the third network node may further receive an eleventh message, from the second network node, to unsubscribe the PDU session status monitoring service.

After receiving the eleventh message, the third network node may further send a twelfth message, to the second network node, for indicating acknowledge of the execution of the eleventh message.

In an embodiment, the third network node may further receive a thirteenth message, from the second network node, for revoking the session with QoS service, and send a fourteenth message, to the second network node, for indicating acknowledge of execution of the thirteenth message.

In an embodiment, the second network node is an Edge Enabler Server (EES).

Any message as described in above embodiments may be any suitable message, such as a request, a response, a HTTP Post request, a HTTP Get request, a HTTP post response, a HTTP Get response, etc.

The second and third network node may be a physical entity or a virtualized network function. For example, the network node may be any suitable network device or node or entity or function (physical or virtual) which can provide a function for setting up or responding a session with required QoS.

In an embodiment, the second network node may be an Edge Enabler Server (EES).

In an embodiment, the third network node may comprise a Network Exposure Function (NEF).

In another embodiment, a communication system may comprise the first network node, the second network node, and the third network node. The first network node may send a first message for establishing Quality of Service (QoS) session to a second network node. The first message may comprise a service area information, and the service area information is used to indicate that within that area a terminal device is allowed to access functional entities resident in the EDN. The second network node may send a second message for subscribing the event monitoring service of Area of Interest to a third network node. The Area of Interest indicates change of the terminal device presence in the Area of Interest. In an embodiment, the first network node is an Edge Application Server (EAS), and/or the second network node is an Edge Enabler Server (EES), and/or the third network node is Network Exposure Function (NEF).

For example, as shown in FIG. 7, at step 2, NEF may receive a third message, from EES, for subscribing the event monitoring service of location change of the terminal device.

In an embodiment, the message may comprise at least one of User Equipment (UE) Identifier (ID), UE Group ID, Area of Interest, and locationArea5G in it. The Area of Interest indicates change of the terminal device presence in the Area of Interest. The locationArea5G is used to define the geographic and topological area served by EDN which need to be monitored.

At step 4, the NEF may further send a fourth message, to the EES, for indicating acknowledge the execution of the third message.

At step 13, the NEF may further send a fifth message, to the EES, for notifying change of the terminal device presence in the Area of Interest when the terminal device enters or leaves the service area.

At step 14, when the terminal device enters the service area, the NEF may further receive a sixth message, from the EES, for subscribing the event monitoring service of Packet Data Unit (PDU) session status.

After receiving the sixth message, at step 16, the NEF may further send a seventh message, to the EES, for indicating acknowledge the execution of the sixth message.

At step 18, the NEF may further send an eighth message, to the EES, for indicating PDU session status.

At step 19, the NEF may further receive a nineth message, from the EES, for creating an QoS session with required QoS, and send a tenth message at step 21, to the EES, for indicating acknowledge of the execution of the ninth message.

At step 22, the UE leaves the service area, the NEF may receive an eleventh message, from the EES, to unsubscribe the PDU session status monitoring service.

After receiving the eleventh message, at step 24, the NEF may send a twelfth message, to the EES, for indicating acknowledge of the execution of the eleventh message.

At step 25, the NEF may further receive a thirteenth message, from the second network node, for revoking the session with QoS service.

At step 26, the NEF may revoke the session with required QoS. The procedure is described in clause 4.15.6.6 of 3GPP TS 23.502 V17.3.0 to revoke an AF session with required QoS to PCF, and 4.3.4.2 of 3GPP TS 23.502 V17.3.0 for PCF to release the PDU session to UPF via SMF, which is mentioned from step 1b to step 12. When the PDU session between UE and EAS are released, the QoS rules in UPF are deleted.

At step 27, the NEF may further send a fourteenth message, to the EES, for indicating acknowledge of execution of the thirteenth message.

FIG. 7 shows a flowchart of a method according to an embodiment of the present disclosure.

At step 1, EAS may send a request to EES to request establishment of a data session between UE and EAS with a specific QoS (either QoS reference or bandwidth). The request may comprise a new attribute Service Area in it. The request may further comprise at least one of UE ID, User Equipment (UE) Identifier (ID), UE Group ID, UE IP, DNN, S-NSSAI and Specific QoS reference in it. The identification information of a UE may be an identifier or a UE address (such as IP address or MAC (Media Access Control) address), SUPI, MSISDN, external ID.

After receiving this request, the EES may check if the EAS is authorized for this operation for UE. If authorized, then EES may execute step 2. Otherwise, the EES may execute step 11 and provides a rejection response with cause information.

If the request is for a group of UEs identified by the UE Group ID or for a single UE identified by the UE ID and Service Area is requested, then EES may map the Service Area to the “geographicAreas” in locationArea5G data Type. The locationArea5G is introduced in table 5.2.1.2.17-1, 3GPP TS 29.122 V17.5.0. Then EES executes step 2.
Type: LocationArea5G

This data type represents the user location area which is sent from the Application Function (AF) to the Service Capability Exposure Function (SCEF).

TABLE 5.2.1.2.17-1
Definition of the LocationArea5G data Type

| Attribute name | Data type | Cardinality | Description |
|---|---|---|---|
| geographicAreas | array(GeographicArea) | 0. . .N | Identifies |
| | | | a list of |
| | | | geographic |
| | | | area of the |
| | | | user where the |
| | | | UE is located. |
| civicAddresses | array(CivicAddress) | 0. . .N | Identifies a |
| | | | list of civic |
| | | | addresses |
| | | | of the user |
| | | | where the UE |
| | | | is located. |
| nwAreaInfo | NetworkAreaInfo | 0. . .1 | This IE |
| | | | represents |
| | | | the network |
| | | | area |
| | | | information |
| | | | of the user |
| | | | where the UE |
| | | | is located. |

If the request is for a group of UEs identified by the UE Group ID or for a single UE identified by the UE ID and no Service Area is requested, then the EES executes step 5.

At step 2, EES may subscribe to one or several Event(s) (identified by Event ID) by sending Nnef_EventExposure_Subscribe request.

Event Reporting Information defines the type of reporting requested (e.g. one-time reporting, periodic reporting or event based reporting, for Monitoring Events). If the reporting event subscription is authorized by the NEF, the NEF records the association of the event trigger and the requester identity. The subscription may also include Maximum number of reports and/or Maximum duration of reporting IE and optionally MTC Provider Information.

If subscription to group-based event notifications are removed or added for certain UEs in a group of UEs for which there is an event notification subscription, the EES provides impacted UE information with operation indication which is either cancellation or addition to NEF via Nnef_EventExposure_Subscribe subscription request.

At step 2, EES may send a subscribe request to NEF. It revokes the Event Monitoring service through Nnef_EventExposure_Subscribe service. The Nnef_EventExposure_Subscribe service is described in 5.2.6.2.2 of 3GPP TS 23.502 V17.3.0. The request may comprise at least one of UE ID, Area of Interest, and locationArea5G in it. The Area of Interest indicates change of the terminal device presence in the Area of Interest. The locationArea5G is used to define the geographic and topological area. Both “Move in” and “Move out” policies are applied.

At step3, after receiving the subscribe request, NEF may subscribe to Area of Interest monitoring event. The procedure is described in clause 4.15.3.2.3 of 3GPP TS 23.502 V17.3.0. When “monitoring Type” is “AREA_OF_INTEREST”, NEF requests to be notified when the UE moves in or out of the geographic area. The detailed illustration about “AREA OF INTEREST” is given in table 5.3.2.4.3-1 of 3GPP TS 29.122 V17.4.0.

TABLE 5.3.2.4.3-1
Enumeration Monitoring Type

| | | Applicability |
|---|---|---|
| Enumeration value | Description | (NOTE 1) |
| AREA_OF_INTEREST | The SCS/AS requests to | UAV |
| | be notified when the | |
| | UAV moves in or out | |
| | of the geographic area. | |

NOTE 1:
Properties marked with a feature as defined in subclause 5.3.4 are applicable as described in subclause 5.2.7. If no features are indicated, the related property applies for all the features.
NOTE 2:
More monitoring types can be added in the future based on stage 2.

At step4, NEF may send EES a response message to acknowledge the execution of Nnef_EventExposure_Subscribe to the requester that initiated the request. If the NEF has received the first event report in step 4, the NEF may include the event report in the acknowledgement. Whether the monitored UE is in the service area may indicate by the uavPresInd attribute. This attribute will be sent back to the EES together with the event report. The detailed illustration of uavPresInd is given at table 5.3.2.3.2-1 in 3GPP TS 29.122 V17.4.0.

TABLE 5.3.2.3.2-1
Definition of type MonitoringEventReport

| Attribute | Data | | | Applicability |
|---|---|---|---|---|
| name | type | Cardinality | Description | (NOTE 1) |
| uavPresInd | boolean | 0. . .1 | If “monitoringType” is | UAV |
| | | | “AREA_OF_INTEREST”, | |
| | | | this parameter shall be set | |
| | | | to true if the specified | |
| | | | UAV is in the monitoring | |
| | | | area. Set to false or | |
| | | | omitted otherwise. | |

NOTE 1:
Properties marked with a feature as defined in subclause 5.3.4 are applicable as described in subclause 5.2.7. If no features are indicated, the related property applies for all the features.
NOTE 2:
Identifies the user for which the event occurred. At least one of the properties shall be included.

At step5, based on the received event report from Step 4, EES may check whether UE is in the service or not. If the UE is in the service, EES may invoke the Event Monitoring service for PDU session status to NEF through Nnef_EventExposure_Subscribe service. EES may send a subscribe request to NEF. The request comprises UE ID and PDU session status in it.

If UE is not in the service area, EES may execute step 11, and may wait for further notification for the Area of Interest monitor response of step 12.

At step 6, NEF may subscribe to PDU session status monitoring event. The procedure is described in clause 4.15.3.2.3 of 3GPP TS 23.502.

At step 7, NEF may send EES a response message to acknowledge the execution of Nnef_EventExposure_Subscribe to the requester that initiated the request.

NEF checks if UE already has ongoing PDU session between UE and EAS. If UE (single UE or UE group member) already has ongoing PDU session, then UE IP address is retrieved. The EES may execute step 8. Otherwise, the EES may wait for further notification for PDU session status.

At step 8, EES may invoke the Session with QoS service to NEF. EES may send a QoS create request to NEF through Nnef_AfsessionWithQos service.

At step 9, NEF may setup the session with required QoS. The procedure is described in clause 4.15.6.6 of 3GPP TS 23.502 V17.3.0 to setup an AF session with required QoS to PCF, and 4.3.3.2 of 3GPP TS 23.502 V17.3.0 for PCF to modify the PDU session to UPF via SMF, including QoS modification.

At step 10, NEF may acknowledge the execution of Nnef_AFsessionWithQos Create request.

At step 11, EES may send a response message to the EAS. The response message may comprise a Context ID and a Result. The Context ID is to be used by the EAS for further requests (e.g. session with QoS update requests) pertaining to the same UE.

If the EAS is not authorized or any other failure happens during step 1, the EES provides a rejection response with cause information.

At step 12, NEF may receive Area of Interest notification if Event Monitoring service for Area of Interest is subscribed in step 3. The procedure is described in clause 4.15.3.2.3 of 3GPP TS 23.502 V17.3.0.

At step 13, NEF may send the Area of Interest notification to EES. The notification is sent through Nnef_EventExposure_Notify service.

Basing on the Area of Interest notification, if UE moves into the service area, then EES may execute steps 14~21. If UE moves out of the service area, then the EES executes steps 22~27.

At step 14, based on the received event report from Step 4, EES checks whether UE is in the service or not. If the UE is in the service, EES invokes the Event Monitoring service for PDU session status to NEF through Nnef_EventExposure_Subscribe service. EES sends a subscribe request to NEF. The request comprises UE ID and PDU session status in it.

At step 15, NEF subscribes to PDU session status monitoring event. The procedure is described in clause 4.15.3.2.3 of 3GPP TS 23.502 V17.3.0.

At step 16, NEF sends EES a response message to acknowledge the execution of Nnef_EventExposure_Subscribe to the requester that initiated the request at step 14.

At step 17, if step 7 is executed and the NEF is waiting for PDU session status notification, the NEF may receive PDU session status notification. The procedure is described in clause 4.15.3.2.3 of 3GPP TS 23.502 V17.3.0.

At step 18, if step 17 is executed, the NEF may send PDU session status notification to EES. The notification message is sent through Nnef_EventExposure_Notify service.

At step 19, the EES may invoke the Session with QoS service to the NEF. The EES may send a QoS create request to the NEF through Nnef_AfsessionWithQos service.

At step 20, the NEF may setup the session with required QoS. The procedure is described in clause 4.15.6.6 of 3GPP TS 23.502 V17.3.0 to setup an AF session with required QoS to PCF, and 4.3.3.2 of 3GPP TS 23.502 V17.3.0 for PCF to modify the PDU session to UPF via SMF, including QoS modification.

At step 21, the NEF may acknowledge the execution of Nnef_AFsessionWithQos Create request.

If the EES receives a notification from the NEF, which indicates UE move out of the service area in step 13, then the EES may execute steps 22 ~ 27.

At step 22, the EES may invoke unsubscribes the PDU session status monitoring event to NEF. It may send a request to NEF through Nnef_EventExposure_Unsubscribe service. The request comprises UE ID and PDU session status in it.

At step 23, the NEF may unsubscribe the PDU session status monitoring event. The procedure is described in clause 4.15.3.2.3 of 3GPP TS 23.502 V17.3.0.

At step 24, the NEF may send a response to the EES to acknowledge the execution of Nnef_EventExposure_UnSubscribe request.

At step 25, the EES may revoke the Session with QoS service to the NEF. It may send a request to the NEF through Nnef_AFsessionWithQos Revoke request.

At step 26, the NEF may revoke the session with required QoS. The procedure is described in clause 4.15.6.6 of 3GPP TS 23.502 V17.3.0 to revoke an AF session with required QoS to PCF, and 4.3.4.2 of 3GPP TS 23.502 V17.3.0 for PCF to release the PDU session to UPF via SMF, which is mentioned from step 1b to step 12. When the PDU session between UE and EAS are released, the QoS rules in UPF are deleted.

At step 27, the NEF may send a response to the EES to acknowledge the execution of Nnef_AFsessionWithQos Revoke request.

In some embodiments herein, it proposes a solution to monitor the UE location when UE enters or leaves the service area of EDN, and remove the unnecessary communication messages between core network and EDN when UE moves out of the service area of EDN. In some embodiments herein, it proposes a solution to monitor the UE location when UE enters or leaves the service area of EDN, and delete the unnecessary storage space in user plane when UE moves out of the service area of EDN.

According to the proposed solution, there is no PDU session status notification messages from 3GPP core network to EES when UE is moved out of the EES service area. Because the PDU session status subscription is removed when UE is out of the area. It reduces the the EDN and 3GPP network resource consumption to continuously monitor the UE PDU session.

Meanwhile, based on the proposed solution, the QoS session between UE and EAS are revoked when UE moves out of the service area. The configurations and resources related with this QoS session which stored on UE, EAS, PCF, UPF, etc. are deleted. The resources of the network nodes in EDN and Core networks which maintain the useless QoS session are removed. Further, based on the proposed solution, when the PDU session between UE and EAS are released, the QoS rules in UPF are deleted. So there is no waste QoS rules installed in RAN and UPF.

The proposed method could effectively save the communication resources and storage resources. The embodiments herein are not limited to the features and advantages mentioned above. A person skilled in the art will recognize additional features and advantages upon reading the following detailed description.

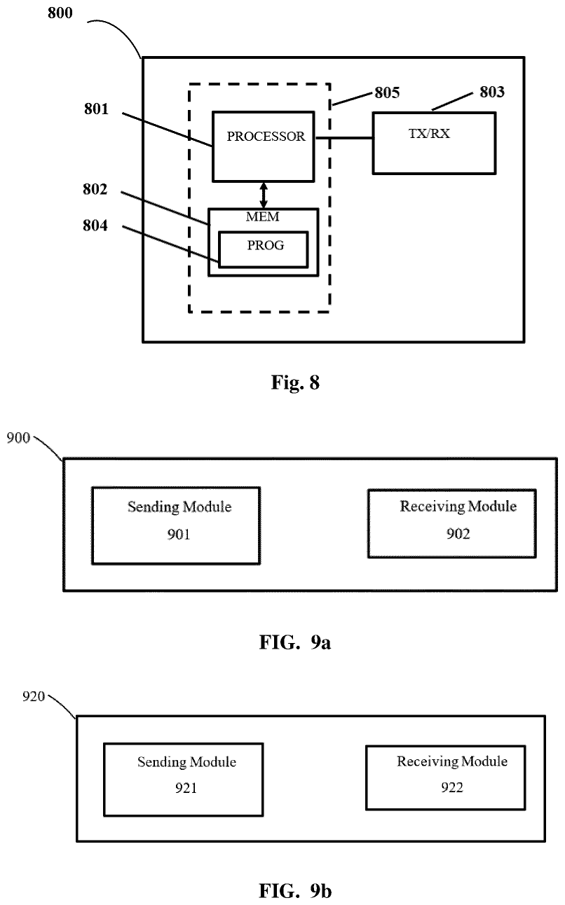

FIG. 8 is a block diagram showing an apparatus suitable for practicing some embodiments of the disclosure. For example, any one of the network nodes described above may be implemented as or through the apparatus 800.

The apparatus 800 comprises at least one processor 801, such as a digital processor (DP), and at least one memory (MEM) 802 coupled to the processor 801. The apparatus 800 may further comprise a transmitter TX and receiver RX 803 coupled to the processor 801. The MEM 802 stores a program (PROG) 804. The PROG 804 may include instructions that, when executed on the associated processor 801, enable the apparatus 800 to operate in accordance with the embodiments of the present disclosure. A combination of the at least one processor 801 and the at least one MEM 802 may form processing means 805 adapted to implement various embodiments of the present disclosure.

Various embodiments of the present disclosure may be implemented by computer program executable by one or more of the processor 801, software, firmware, hardware or in a combination thereof.

The MEM 802 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 801 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the network node, the memory 802 contains instructions executable by the processor 801, whereby the network node operates according to any of the methods related to the network node as described above.

In an embodiment where the apparatus is implemented as or at the application node, the memory 802 contains instructions executable by the processor 801, whereby the application node operates according to any of the methods related to the application node as described above.

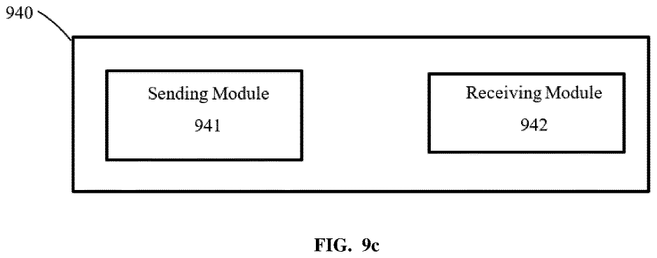

FIG. 9a is a block diagram showing a network node according to an embodiment of the disclosure.

As shown, the first network node 900 comprises a first sending module 901. The first sending module 901 may be configured to send a first message for establishing Quality of Service (QoS) session to a second network node. The first message comprising a service area information; and wherein the service area information is used to indicate that within that area a terminal device is allowed to access functional entities resident in the EDN.

In an embodiment, the network node 800 further comprises a receiving module 902 configured to receive a second message for responding the QoS session establishment from the second network node.

FIG. 9b is a block diagram showing a network node according to an embodiment of the disclosure.

As shown, the second network node 920 comprises a receiving module 921. The first receiving module 1001 may be configured to receive a first message for establishing QoS session from a first network node. The first message comprising a service area information. The service area information is used to indicate that within that area a terminal device is allowed to access functional entities resident in the EDN.

In an embodiment, the second network node 920 further comprises a sending module 922 configured to send a second message for responding the QoS session establishment to the first network node.

In another embodiment, the second network node 920 is further configured to send a third message for subscribing the event monitoring service of Area of Interest to a third network node. The Area of Interest indicates change of the terminal device presence in the Area of Interest.

In another embodiment, the second network node 920 is further configured to receive a fourth message for indicating acknowledge the execution of the subscribing the event monitoring service of Area of Interest from the third network node.

In another embodiment, the second network node 920 is further configured to receive a fifth message, from the third network node, for notifying change of the terminal device presence in the Area of Interest whether the terminal device enters or leaves the service area.

In another embodiment, the second network node 920 is further configured to send a sixth message, to the third network node, for subscribing the event monitoring service of Packet Data Unit (PDU) session status when the terminal device enters the service area.

In another embodiment, the second network node 920 is further configured to receive a seventh message, from the third network node, for indicating acknowledge the execution of the sixth message.

In another embodiment, the second network node 920 is further configured to receive an eighth message, from the third network node, for indicating PDU session status.

In another embodiment, the second network node 920 is further configured to send a ninth, to the third network node, for creating an QoS session with required QoS.

In another embodiment, the second network node 920 is further configured to receive a tenth message, from the third network node, for indicating acknowledge of the execution of the ninth message.

In another embodiment, the second network node 920 is further configured to send an eleventh message to the third network node, for unsubscribing the event monitoring service of PDU session status when the terminal device leaves the service area.

In another embodiment, the second network node 920 is further configured to receive a twelfth message, from the third network node, for indicating acknowledge of the eleventh message.

In another embodiment, the second network node 920 is further configured to send a thirteenth message, to the third network node, for revoking the session with QoS service.

In another embodiment, the second network node 920 is further configured to receive a fourteenth message, from the third network node, indicating acknowledge of execution of the thirteenth message.

FIG. 9c is a block diagram showing a network node according to an embodiment of the disclosure.

As shown, the third network node 940 comprises a receiving module 941. The first receiving module 1001 may be configured to receive a third message, from the second network node, for subscribing the event monitoring service of location change of the terminal device.

In an embodiment, the third network node 940 further comprises a sending module 1102 configured to send a fourth message, to the second network node, for indicating acknowledge the execution of the third message.

In another embodiment, the third network node 940 is further configured to send a fifth message, to the second network node, for notifying change of the terminal device presence in the Area of Interest when the terminal device enters or leaves the service area.

In another embodiment, the third network node 940 is further configured to receive a sixth message, from the second network node, for subscribing the event monitoring service of Packet Data Unit (PDU) session status when the terminal device enters the service area.

In another embodiment, the third network node 940 is further configured to send a seventh message, to the second network node, for indicating acknowledge the execution of the sixth message.

In another embodiment, the third network node 940 is further configured to send an eighth message, to the second network node, for indicating PDU session status.

In another embodiment, the third network node 940 is further configured to receive a nineth message, from the second network node, for creating an QoS session with required QoS. It further comprises a fifth sending module 1108 configured to send a tenth message, to the second network node, for indicating acknowledge of the execution of the ninth message.

In another embodiment, the third network node 940 is further configured to receive an eleventh message, from the second network node, to unsubscribe the PDU session status monitoring service when the terminal device leaves the service area.

In another embodiment, the third network node 940 is further configured to send a twelfth message, to the second network node, for indicating acknowledge of the execution of the eleventh message.

In another embodiment, the third network node 940 is further configured to receive a thirteenth message, from the second network node, for revoking the session with QoS service. It further comprises a seventh sending module 940 configured to send a fourteenth message, to the second network node, for indicating acknowledge of execution of the thirteenth message.

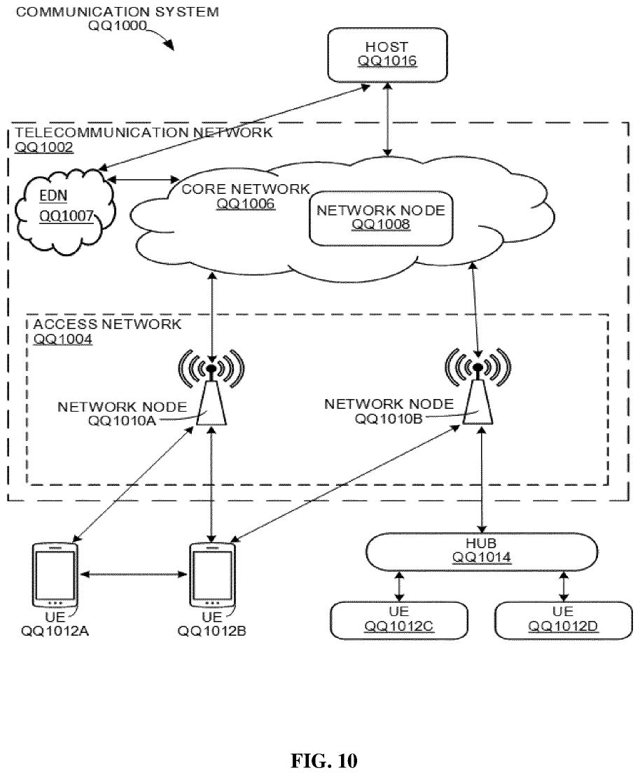

FIG. 10 shows an example of a communication system QQ1000 in accordance with some embodiments.

In the example, the communication system QQ1000 includes a telecommunication network QQ1002 that includes an access network QQ1004, such as a radio access network (RAN), a core network QQ1006, which includes one or more core network nodes QQ1008, and an Edge Data Network (EDN) QQ1007. The access network QQ1004 includes one or more access network nodes, such as network nodes QQ1010a and QQ1010b (one or more of which may be generally referred to as network nodes QQ1010), or any other similar 3rd Generation Partnership Project (3GPP) access node or non-3GPP access point. The network nodes QQ1010 facilitate direct or indirect connection of user equipment (UE), such as by connecting UEs QQ1012a, QQ1012b, QQ1012c, and QQ1012d (one or more of which may be generally referred to as UEs QQ1012) to the core network QQ1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ1000 may include any number of wired or wireless networks, network nodes, UEs, and/or any other components or systems that may facilitate or participate in the communication of data and/or signals whether via wired or wireless connections. The communication system QQ1000 may include and/or interface with any type of communication, telecommunication, data, cellular, radio network, and/or other similar type of system.

The UEs QQ1012 may be any of a wide variety of communication devices, including wireless devices arranged, configured, and/or operable to communicate wirelessly with the network nodes QQ1010 and other communication devices. Similarly, the network nodes QQ1010 are arranged, capable, configured, and/or operable to communicate directly or indirectly with the UEs QQ1012 and/or with other network nodes or equipment in the telecommunication network QQ1002 to enable and/or provide network access, such as wireless network access, and/or to perform other functions, such as administration in the telecommunication network QQ1002.

In the depicted example, the core network QQ1006 connects the network nodes QQ1010 to one or more hosts, such as host QQ1016. These connections may be direct or indirect via one or more intermediary networks or devices. In other examples, network nodes may be directly coupled to hosts. The core network QQ1006 includes one more core network nodes (e.g., core network node QQ1008) that are structured with hardware and software components. Features of these components may be substantially similar to those described with respect to the UEs, network nodes, and/or hosts, such that the descriptions thereof are generally applicable to the corresponding components of the core network node QQ1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF), Control Function (PCF), Unified Data Management (UDM), etc.

The Edge Data Network (EDN) QQ1007 connects the core network Q1006 and HOST QQ1016. These connections may be direct or indirect via one or more intermediary networks or devices. In other examples, the network nodes in EDN may be directly coupled to hosts in QQ1016. In other examples, the network nodes in EDN may be directly coupled to core network nodes QQ1008. The EDN QQ1007 includes one or more edge network nodes that are structured with hardware and software components. Features of these components may be substantially similar to those described with respect to the UEs, network nodes, and/or hosts. Example edge network nodes include functions of one or more of a Edge Application Server (EAS), Edge Enabler Server (EES), Edge Configuration Server (ECS), Edge Enabler Client (EEC).

The host QQ1016 may be under the ownership or control of a service provider other than an operator or provider of the access network QQ1004 and/or the telecommunication network QQ1002, and may be operated by the service provider or on behalf of the service provider. The host QQ1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ1002 is a cellular network that implements 3GPP standardized features. Accordingly, the telecommunications network QQ1002 may support network slicing to provide different logical networks to different devices that are connected to the telecommunication network QQ102. For example, the telecommunications network QQ1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ1012 are configured to transmit and/or receive information without direct human interaction. For instance, a UE may be designed to transmit information to the access network QQ1004 on a predetermined schedule, when triggered by an internal or external event, or in response to requests from the access network QQ1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ1014 communicates with the access network QQ1004 to facilitate indirect communication between one or more UEs (e.g., UE QQ1012c and/or QQ1012d) and network nodes (e.g., network node QQ1010b). In some examples, the hub QQ1014 may be a controller, router, content source and analytics, or any of the other communication devices described herein regarding UEs. For example, the hub QQ1014 may be a broadband router enabling access to the core network QQ1006 for the UEs. As another example, the hub QQ1014 may be a controller that sends commands or instructions to one or more actuators in the UEs. Commands or instructions may be received from the UEs, network nodes QQ1010, or by executable code, script, process, or other instructions in the hub QQ1014. As another example, the hub QQ1014 may be a data collector that acts as temporary storage for UE data and, in some embodiments, may perform analysis or other processing of the data. As another example, the hub QQ1014 may be a content source. For example, for a UE that is a VR headset, display, loudspeaker or other media delivery device, the hub QQ1014 may retrieve VR assets, video, audio, or other media or data related to sensory information via a network node, which the hub QQ1014 then provides to the UE either directly, after performing local processing, and/or after adding additional local content. In still another example, the hub QQ1014 acts as a proxy server or orchestrator for the UEs, in particular in if one or more of the UEs are low energy IoT devices.

The hub QQ1014 may have a constant/persistent or intermittent connection to the network node QQ1010b. The hub QQ1014 may also allow for a different communication scheme and/or schedule between the hub QQ1014 and UEs (e.g., UE QQ1012c and/or QQ1012d), and between the hub QQ1014 and the core network QQ1006. In other examples, the hub QQ1014 is connected to the core network QQ1006 and/or one or more UEs via a wired connection. Moreover, the hub QQ1014 may be configured to connect to an M2M service provider over the access network QQ1004 and/or to another UE over a direct connection. In some scenarios, UEs may establish a wireless connection with the network nodes QQ1010 while still connected via the hub QQ1014 via a wired or wireless connection. In some embodiments, the hub QQ1014 may be a dedicated hub—that is, a hub whose primary function is to route communications to/from the UEs from/to the network node QQ1010b. In other embodiments, the hub QQ1014 may be a non-dedicated hub—that is, a device which is capable of operating to route communications between the UEs and network node QQ1010b, but which is additionally capable of operating as a communication start and/or end point for certain data channels.

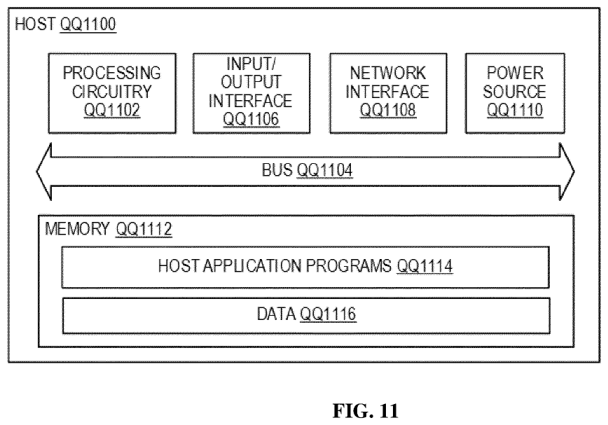

FIG. 11 is a block diagram of a host QQ100, which may be an embodiment of the host QQ1016 of FIG. 10, in accordance with various aspects described herein. As used herein, the host QQ1100 may be or comprise various combinations hardware and/or software, including a standalone server, a blade server, a cloud-implemented server, a distributed server, a virtual machine, container, or processing resources in a server farm. The host QQ1100 may provide one or more services to one or more UEs.

The host QQ1100 includes processing circuitry QQ1102 that is operatively coupled via a bus QQ1104 to an input/output interface QQ1106, a network interface QQ1108, a power source QQ1110, and a memory QQ1112.

The memory QQ1112 may include one or more computer programs including one or more host application programs QQ1114 and data QQ1116, which may include user data, e.g., data generated by a UE for the host QQ1100 or data generated by the host QQ1100 for a UE. Embodiments of the host QQ1100 may utilize only a subset or all of the components shown. The host application programs QQ1114 may be implemented in a container-based architecture and may provide support for edge applications, video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ1114 may also provide for user authentication and licensing checks and may periodically report health, routes, and content availability to a central node, such as a device in or on the edge of a core network. Accordingly, the host QQ1100 may select and/or indicate a different host for over-the-top services for a UE. The host application programs QQ1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

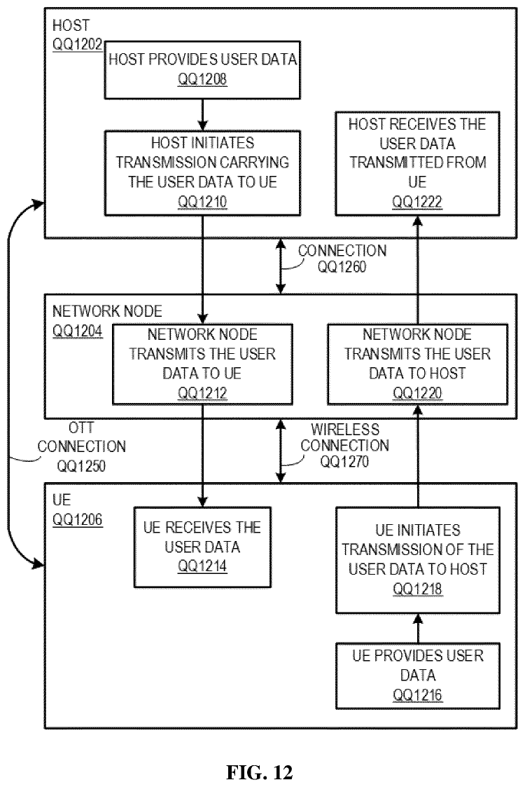

FIG. 12 shows a communication diagram of a host QQ1202 communicating via a network node QQ1204 with a UE QQ1206 over a partially wireless connection in accordance with some embodiments. Example implementations, in accordance with various embodiments, of the UE (such as a UE QQ1012a of FIG. 10), network node (such as network node QQ1010a of FIG. 10), and host (such as host QQ1016 of FIG. 10 and/or host QQ1100 of FIG. 11) discussed in the preceding paragraphs will now be described with reference to FIG. 12.

Like host QQ1100, embodiments of host QQ1202 include hardware, such as a communication interface, processing circuitry, and memory. The host QQ1202 also includes software, which is stored in or accessible by the host QQ1202 and executable by the processing circuitry. The software includes a host application that may be operable to provide a service to a remote user, such as the UE QQ1206 connecting via an over-the-top (OTT) connection QQ1250 extending between the UE QQ1206 and host QQ1202. In providing the service to the remote user, a host application may provide user data which is transmitted using the OTT connection QQ1250.

The network node QQ1204 includes hardware enabling it to communicate with the host QQ1202 and UE QQ1206. The connection QQ1260 may be direct or pass through a core network (like core network QQ1006 of FIG. 10) and/or one or more other intermediate networks, such as one or more public, private, or hosted networks. For example, an intermediate network may be a backbone network or the Internet.

The UE QQ1206 includes hardware and software, which is stored in or accessible by UE QQ1206 and executable by the UE's processing circuitry. The software includes a client application, such as a web browser or operator-specific “app” that may be operable to provide a service to a human or non-human user via UE QQ1206 with the support of the host QQ1202. In the host QQ1202, an executing host application may communicate with the executing client application via the OTT connection QQ1250 terminating at the UE QQ1206 and host QQ1202. In providing the service to the user, the UE's client application may receive request data from the host's host application and provide user data in response to the request data. The OTT connection QQ1250 may transfer both the request data and the user data. The UE's client application may interact with the user to generate the user data that it provides to the host application through the OTT connection QQ1250.

The OTT connection QQ1250 may extend via a connection QQ1260 between the host QQ1202 and the network node QQ1204 and via a wireless connection QQ1270 between the network node QQ1204 and the UE QQ1206 to provide the connection between the host QQ1202 and the UE QQ1206. The connection QQ1260 and wireless connection QQ1270, over which the OTT connection QQ1250 may be provided, have been drawn abstractly to illustrate the communication between the host QQ1202 and the UE QQ1206 via the network node QQ1204, without explicit reference to any intermediary devices and the precise routing of messages via these devices.

As an example of transmitting data via the OTT connection QQ1250, in step QQ1208, the host QQ1202 provides user data, which may be performed by executing a host application. In some embodiments, the user data is associated with a particular human user interacting with the UE QQ1206. In other embodiments, the user data is associated with a UE QQ1206 that shares data with the host QQ1202 without explicit human interaction. In step QQ1210, the host QQ1202 initiates a transmission carrying the user data towards the UE QQ1206. The host QQ1202 may initiate the transmission responsive to a request transmitted by the UE QQ1206. The request may be caused by human interaction with the UE QQ1206 or by operation of the client application executing on the UE QQ1206. The transmission may pass via the network node QQ1204, in accordance with the teachings of the embodiments described throughout this disclosure. Accordingly, in step QQ1212, the network node QQ1204 transmits to the UE QQ1206 the user data that was carried in the transmission that the host QQ1202 initiated, in accordance with the teachings of the embodiments described throughout this disclosure. In step QQ1214, the UE QQ1206 receives the user data carried in the transmission, which may be performed by a client application executed on the UE QQ1206 associated with the host application executed by the host QQ1202.

In some examples, the UE QQ1206 executes a client application which provides user data to the host QQ1202. The user data may be provided in reaction or response to the data received from the host QQ1202. Accordingly, in step QQ1216, the UE QQ1206 may provide user data, which may be performed by executing the client application. In providing the user data, the client application may further consider user input received from the user via an input/output interface of the UE QQ1206. Regardless of the specific manner in which the user data was provided, the UE QQ1206 initiates, in step QQ1218, transmission of the user data towards the host QQ1202 via the network node QQ1204. In step QQ1220, in accordance with the teachings of the embodiments described throughout this disclosure, the network node QQ1204 receives user data from the UE QQ1206 and initiates transmission of the received user data towards the host QQ1202. In step QQ1222, the host QQ1202 receives the user data carried in the transmission initiated by the UE QQ1206.

One or more of the various embodiments improve the performance of OTT services provided to the UE QQ1206 using the OTT connection QQ1250, in which the wireless connection QQ1270 forms the last segment. More precisely, the teachings of these embodiments some embodiments herein can optimize the current solution. Some embodiments herein can consider two development cases. In some embodiments herein, it proposed a method to distribute the key of application function in case the VPLMN support or not support AKMA service in AKMA roaming scenario. In some embodiments herein, the key of application function is bound with SN ID, which can resist key leakage attack. In some embodiments herein, when the UE moves to another network, the key KAF used in VPLMN can be deleted both in the UE and VPLMN and cannot be used in HPLMN again, which can resist key leakage attack.

In an example scenario, factory status information may be collected and analyzed by the host QQ1202. As another example, the host QQ1202 may process audio and video data which may have been retrieved from a UE for use in creating maps. As another example, the host QQ1202 may collect and analyze real-time data to assist in controlling vehicle congestion (e.g., controlling traffic lights). As another example, the host QQ1202 may store surveillance video uploaded by a UE. As another example, the host QQ1202 may store or control access to media content such as video, audio, VR or AR which it can broadcast, multicast or unicast to UEs. As other examples, the host QQ1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ1250 between the host QQ1202 and UE QQ1206, in response to variations in the measurement results. The measurement procedure and/or the network functionality for reconfiguring the OTT connection may be implemented in software and hardware of the host QQ1202 and/or UE QQ1206. In some embodiments, sensors (not shown) may be deployed in or in association with other devices through which the OTT connection QQ1250 passes; the sensors may participate in the measurement procedure by supplying values of the monitored quantities exemplified above, or supplying values of other physical quantities from which software may compute or estimate the monitored quantities. The reconfiguring of the OTT connection QQ1250 may include message format, retransmission settings, preferred routing etc.; the reconfiguring need not directly alter the operation of the network node QQ1204. Such procedures and functionalities may be known and practiced in the art. In certain embodiments, measurements may involve proprietary UE signaling that facilitates measurements of throughput, propagation times, latency and the like, by the host QQ1202. The measurements may be implemented in that software causes messages to be transmitted, in particular empty or ‘dummy’ messages, using the OTT connection QQ1250 while monitoring propagation times, errors, etc.

Embodiment 1. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform the operations related to the wireless device as described above to transmit the user data from the host to the UE.

Embodiment 2. The host of the previous embodiment, wherein: the processing circuitry of the host is configured to execute a host application that provides the user data; and the UE comprises processing circuitry configured to execute a client application associated with the host application to receive the transmission of user data from the host.

Embodiment 3. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs the operations related to the wireless device as described above to transmit the user data from the host to the UE.

Embodiment 4. The method of the previous embodiment, further comprising, at the network node, transmitting the user data provided by the host for the UE.

Embodiment 5. The method of any of the previous 2 embodiments, wherein the user data is provided at the host by executing a host application that interacts with a client application executing on the UE, the client application being associated with the host application.

Embodiment 6.A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform the operations related to the wireless device as described above to transmit the user data from the host to the UE.

Embodiment 7. The communication system of the previous embodiment, further comprising: the network node; and/or the user equipment.

Embodiment 8. The communication system of the previous 2 embodiments, wherein: the processing circuitry of the host is configured to execute a host application, thereby providing the user data; and the host application is configured to interact with a client application executing on the UE, the client application being associated with the host application.

Embodiment 9. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform the operations related to the wireless device as described above to receive the user data from the UE for the host.

Embodiment 10. The host of the previous 2 embodiments, wherein: the processing circuitry of the host is configured to execute a host application, thereby providing the user data; and the host application is configured to interact with a client application executing on the UE, the client application being associated with the host application.

Embodiment 11. The host of the any of the previous 2 embodiments, wherein the initiating receipt of the user data comprises requesting the user data.

Embodiment 12. A method implemented by a host configured to operate in a communication system that further includes a network node and a user equipment (UE), the method comprising: at the host, initiating receipt of user data from the UE, the user data originating from a transmission which the network node has received from the UE, wherein the network node performs the operations related to the wireless device as described above to receive the user data from the UE for the host.

Embodiment 13. The method of the previous embodiment, further comprising at the network node, transmitting the received user data to the host.

Embodiment 14. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform the operations related to the wireless device as described above to receive the user data from the host.

Embodiment 15. The host of the previous embodiment, wherein the cellular network further includes a network node configured to communicate with the UE to transmit the user data to the UE from the host.

Embodiment 16. The host of the previous 2 embodiments, wherein: the processing circuitry of the host is configured to execute a host application, thereby providing the user data; and the host application is configured to interact with a client application executing on the UE, the client application being associated with the host application.

Embodiment 17. A method implemented by a host operating in a communication system that further includes a network node and a user equipment (UE), the method comprising: providing user data for the UE; and initiating a transmission carrying the user data to the UE via a cellular network comprising the network node, wherein the UE performs the operations related to the wireless device as described above to receive the user data from the host.

Embodiment 18. The method of the previous embodiment, further comprising: at the host, executing a host application associated with a client application executing on the UE to receive the user data from the UE.

Embodiment 19. The method of the previous embodiment, further comprising: at the host, transmitting input data to the client application executing on the UE, the input data being provided by executing the host application, wherein the user data is provided by the client application in response to the input data from the host application.

Embodiment 20. A host configured to operate in a communication system to provide an over-the-top (OTT) service, the host comprising: processing circuitry configured to utilize user data; and a network interface configured to receipt of transmission of the user data to a cellular network for transmission to a user equipment (UE), wherein the UE comprises a communication interface and processing circuitry, the communication interface and processing circuitry of the UE being configured to perform the operations related to the wireless device as described above to transmit the user data to the host.

Embodiment 21. The host of the previous embodiment, wherein the cellular network further includes a network node configured to communicate with the UE to transmit the user data from the UE to the host.

Embodiment 22. The host of the previous 2 embodiments, wherein: the processing circuitry of the host is configured to execute a host application, thereby providing the user data; and the host application is configured to interact with a client application executing on the UE, the client application being associated with the host application.

Embodiment 23. A method implemented by a host configured to operate in a communication system that further includes a network node and a user equipment (UE), the method comprising: at the host, receiving user data transmitted to the host via the network node by the UE, wherein the UE performs the operations related to the wireless device as described above to transmit the user data to the host.

Embodiment 24. The method of the previous embodiment, further comprising: at the host, executing a host application associated with a client application executing on the UE to receive the user data from the UE.

Embodiment 25. The method of the previous embodiments, further comprising: at the host, transmitting input data to the client application executing on the UE, the input data being provided by executing the host application, wherein the user data is provided by the client application in response to the input data from the host application.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a first network node in Edge Data Network (EDN), comprising:
sending a first message for establishing Quality of Service (QoS) session to a second network node;
wherein the first message comprising a service area information; and
wherein the service area information is used to indicate that within that area a terminal device is allowed to access functional entities resident in the EDN.

2. The method according to claim 1, wherein the service area information comprises at least one of:
topological service area identifier; and
geographical service area identifier; and/or
wherein the first message further comprises a terminal device information; and wherein the terminal device information comprising at least one of:
User Equipment (UE) Identifier (ID); and
UE Group ID.

3. (canceled)

4. The method according to claim 1, further comprising:
receiving a second message for responding the QoS session establishment from the second network node.

5. The method according to claim 1, wherein the first network node is an Edge Application Server (EAS); and/or wherein the second network node is an Edge Enabler Server (EES).

6. A method performed by a second network node in Edge Data Network (EDN) network, comprising:
receiving a first message for establishing QoS session from a first network node;
wherein the first message comprising a service area information; and
wherein the service area information is used to indicate that within that area a terminal device is allowed to access functional entities resident in the EDN.

7. The method according to claim 6, wherein the service area information comprises one of:
topological service area identifier; or
geographical Service area identifier.

8. The method according to claim 6, wherein the first message further comprises a terminal device information; and wherein the terminal device information comprising at least one of:
User Equipment (UE) Identifier (ID); and
UE Group ID.

9. The method according to claim 6, further comprising at least one of:
sending a second message for responding the QoS session establishment to the first network node;
mapping the service area to locationArea5G; wherein the locationArea5G is used to indicate the geographic and topological area served by EDN which need to be monitored; and
sending a third message for subscribing the event monitoring service of Area of Interest to a third network node, wherein the Area of Interest indicates change of the terminal device presence in the Area of Interest.

10. (canceled)

11. (canceled)

12. The method according to claim 9, wherein the third message comprising at least one of:
User Equipment (UE) Identifier (ID);
UE Group ID;
Area of Interest; and
locationArea5G, wherein the locationArea5G is used to define the geographic and topological area.

13. The method according to claim 7, further comprising at least one of:
receiving a fourth message for indicating acknowledge the execution of the subscribing the event monitoring service of Area of Interest from the third network node;
receiving a fifth message, from the third network node, for notifying change of the terminal device presence in the Area of Interest whether the terminal device enters or leaves the service area; and
when the terminal device enters the service area, sending a sixth message, to the third network node, for subscribing the event monitoring service of Packet Data Unit (PDU) session status.

14. (canceled)

15. (canceled)

16. The method according to claim 13, further comprising:
receiving a seventh message, from the third network node, for indicating acknowledge the execution of the sixth message;
receiving an eighth message, from the third network node, for indicating PDU session status; and
sending a ninth message, to the third network node, for creating an QoS session with required QoS; and
receiving a tenth message, from the third network node, for indicating acknowledge of the execution of the ninth message.

17. (canceled)

18. (canceled)

19. The method according to claim 6, when the terminal device leaves the service area, further comprising:
sending an eleventh message to the third network node, for unsubscribing the event monitoring service of PDU session status;
receiving a twelfth message, from the third network node, for indicating acknowledge of the eleventh message;
sending a thirteenth message, to the third network node, for revoking the session with OoS service; and
receiving a fourteenth message, from the third network node, indicating acknowledge of execution of the thirteenth message.

20. (canceled)

21. (canceled)

22. The method according to claim 7, wherein the first network node is an Edge Application Server (EAS); and/or wherein the second network node is an Edge Enabler Server (EES); and/or wherein the third network node is Network Exposure Function (NEF).

23. A method performed by a third network node in Edge Data Network (EDN) network, comprising:
receiving a third message, from the second network node, for subscribing the event monitoring service of location change of the terminal device.

24. The method according to claim 23, wherein the message comprising at least one of:
User Equipment (UE) Identifier (ID);
UE Group ID;
Area of Interest, wherein the Area of Interest indicates change of the terminal device presence in the Area of Interest; and
locationArea5G, wherein the locationArea5G is used to define the geographic and topological area served by EAS.

25. The method according to claim 23, further comprising:
sending a fourth message, to the second network node, for indicating acknowledge the execution of the third message;
sending a fifth message, to the second network node, for notifying change of the terminal device presence in the Area of Interest when the terminal device enters or leaves the service area;
when the terminal device enters the service area, receiving a sixth message, from the second network node, for subscribing the event monitoring service of Packet Data Unit (PDU) session status when the terminal device enters the service area.

26. (canceled)

27. (canceled)

28. The method according to claim 25, further comprising:
sending a seventh message, to the second network node, for indicating acknowledge the execution of the sixth message;
sending an eighth message, to the second network node, for indicating PDU session status;
receiving a ninth message, from the second network node, for creating an QoS session with required QoS; and
sending a tenth message, to the second network node, for indicating acknowledge of the execution of the ninth message.

29. (canceled)

30. (canceled)

31. The method according to claim 23, when the terminal device leaves the service area, further comprising:
receiving an eleventh message, from the second network node, to unsubscribe the PDU session status monitoring service when the terminal device leaves the service area; and
sending a twelfth message, to the second network node, for indicating acknowledge of the execution of the eleventh message.

32. (canceled)

33. The method according to claim 31, further comprising:
receiving a thirteenth message, from the second network node, for revoking the session with QoS service; and
sending a fourteenth message, to the second network node, for indicating acknowledge of execution of the thirteenth message.

34. The method according to claim 23, wherein the second network node is an Edge Enabler Server (EES); and wherein the third network node is Network Exposure Function (NEF).

35.-43. (canceled)
